(19) United States
(12) Patent Application Publication
(10) Pub. No.: US 2005/0137964 A1
(43) Pub. Date: Jun. 23, 2005

(54) System and method for real-time options trading over a computer network

(75) Inventors: Mark A. Nordlicht, New York, NY (US); Yechiel A. Zucker, New York, NY (US); Howard A. Feder, Woodmere, NY (US); David Boim, New York, NY (US)

Correspondence Address: DARBY & DARBY P.C., P. O. BOX 5257, NEW YORK, NY, 10150-5257, US

(73) Assignee: Optionable, Inc., Briarcliff Manor, NY (US)

(21) Appl. No.: 11/060,455

(22) Filed: Feb. 17, 2005

Related U.S. Application Data
(62) Division of application No. 09/653,102, filed on Aug. 31, 2000.

(51) Int. Cl. G06F 17/60

(52) U.S. Cl. 705/37

(57) ABSTRACT

The present invention discloses a system for real-time trading of options contracts between a plurality of traders over a computer network. The system includes a computer network, a market server, and two or more trader clients. The market server is operably connected to the computer network. The two or more trader clients are operably corrected to the computer network such that each of the trader clients can be placed into operable communication with the market server. Each of the trade clients facilitates entry and transmission of commands in substantially real-time to the market server and display of substantially real-time updates from the market server. The trader client commands include trade orders wherein the market server distributes the trade orders and any executions of same to each of the trader clients in substantially-real time.

### FIELD OF THE INVENTION

The present invention relates to online systems and methods and, more particularly, to systems and methods that facilitate real-time options trading over a computer network, such as the Internet.

### BACKGROUND OF THE INVENTION

Options are legally binding agreements that grant the holder the right, but not the obligation, to buy or sell an underlying (i.e. crude oil, cotton, wheat) on a particular date some time in the future at a set price. Options contracts generally have a set quality, quantity, delivery time, strike price, expiration date and location depending upon the type of underlying associated with them. The only “negotiated” variable is price (or “premium”), which has traditionally been discovered on the floors of exchanges, such as the Chicago Board of Trade, through the open outcry auction market system. This process allows buyers and sellers to consummate trades by offering verbal bids and offers.

Certain terminology is essential in the field of option trading. A CALL is the right, but not the obligation to buy, for instance, an underlying commodity at a specific price (strike price) up until a specific time in the future (expiration date). A PUT is the right but not the obligation to sell the underlying commodity at a specific price up until a specific point in the fixture. A CALL SPREAD is when you simultaneously buy one call and sell another. An example would be the simultaneous buying of a May 50 call and selling of a May 55 call. If they were in different months it would be a known as CALENDAR CALL spread which would be the simultaneous buying of a May 50 call and selling of a July 50 call. A STRADDLE is the simultaneous buying of a call and a put of the same strike in the same month. So one would be buying say, a 50 call and buying the 50 put. Another trade type is a FENCE which would be the simultaneous buying of a put and selling a call (or selling the put and buying the call). If one executes these trades in different months it is a “calendar” fence. Many option trades are carried out by combining multiple calls or puts in various different combinations (such “Multi-leg”). Other trading types have colorful names such as butterflies, strangles, calendar spreads, christmas trees, condors, iron butterflies, etc. . . . —each involving different trading strategies, For instance, a butterfly is the sale (purchase) of two options with the same strike price, together with the purchase (sale) of one option with a lower strike price and one option with a higher strike price. All options must be of the same type (call or put), have the same expiration date and, there must be an equal increment between strike prices. Some types of options trades and strategies could have even say 12 legs. Every trade or option strategy is just a combination of calls and puts and one must have an understanding of each option type—its pattern and how many legs it would have.

Options trading is typically conducted on a trading floor in an “open outcry” system which allows for quick assimilation of market information where buyers counterbalance sellers and ultimately arrive at a fair market value for the contracts. However, the open outcry system does not always provide for price transparency—making it difficult for some consumers to directly participate in the process. Furthermore, as the volume and volatility of the futures market continues to increase, it is becoming more difficult to handle the administrative challenges presented by the open-outcry system. For these reasons, among others, there is a need for a different approach to options trading.

One potential solution is the use of electronic order entry. However, unlike open outcry, traders in a computerized setting cannot “see” the market participants, “feel” the interest in a particular instrument.

It is therefore an object of the present invention to provide a system and method for real-time options trading over a computer network (hereafter EOT) which provides human market participants with the feel of an exchange floor with the convenience of computerized organization.

### SUMMARY OF THE INVENTION

The above problems are solved, and a number of technical advances are achieved in the art, by implementation of a system and method for real-time options trading over a global computer network, such as the Internet. In particular, the present invention discloses a system for real-time trading of options contracts between a plurality of traders over a computer network. The system includes a computer network, a market server, and two or more trader clients.

The market server is operably connected to the computer network. The market server additionally processes and executes matched trade orders in substantially real time. The market server further matches trade orders only where each party to said matched trade is identified by the other party as an accepted counterparty. The market server may also preclude execution of a trade based on credit available to the human trader.

The two or more trader clients are operably connected to the computer network such that each of the trader clients can be placed into operable communication with the market server. Each of the trader clients facilitates entry and transmission of commands in substantially real-time to the market server and display of substantially real-time updates from the market server. Each of the trader clients further provides information to the human trader regarding a desired underlying commodity market as received from the market server. Each trader client may then display the underlying commodity information in a working order and filled order windows. The underlying commodity information is alternatively available to the human trader in both summary and detailed form.

The trader client commands include trade orders wherein the market server distributes the trade orders and any executions of same to each of the trader clients in substantially real-time. Each of the trader clients facilitates the entry of the commands by providing a graphical user interface. The trader client may also facilitate the entry of the commands by providing a simplified order entry language.

A further embodiment of the present invention discloses a method for real-time trading of options contracts between a plurality of traders on an underlying commodity over a computer network using a client-server paradigm in a system having multiple clients. The method includes submitting commands to the server, acting upon the commands submitted from multiple clients at the server, and displaying all information from the server regarding the submitted commands. Commands submitted to the server are entered by traders from multiple clients regarding the underlying commodity. Submitting the commands can be facilitated by providing multiple command entry methods. One such entry method involves graphical user interface principles. Another such entry method involves a quick entry language.

Acting upon the commands submitted includes matching trade order commands of at least two traders according to a rules set in substantially real-time. Acting upon the commands further includes validating commands prior to acting further on the command.

Information from the server regarding submitted commands related to the underlying commodity and resulting server actions is displayed in substantially real-time on all of the multiple clients. The display further includes parsing the information into multiple windows depending upon the status of the order.

### BRIEF DESCRIPTION OF THE DRAWING

The foregoing advantageous features of the invention will be described in detail and other advantageous features will be made apparent upon reading the following detailed description that is given with reference to the several figures of the drawings, in which:

FIG. 1 of the drawings is a block diagram overview of the various components of the present inventive system;

FIG. 2 of the drawings shows one potential configuration of information windows in a graphical user interface in one potential embodiment of trader client 200;

FIG. 3 of the drawings is one potential “trade” pull-down menu that may be used in the main application screen of trader client 200;

FIG. 4 of the drawings is one potential order entry dialog box that may be used in one embodiment of trader client 200;

FIG. 5 of the drawings is one potential “view” pull-down menu that may be used in the main application screen of trader client 200;

FIG. 6 of the drawings is a Option Detail Screen in one potential embodiment of trader client 200;

FIG. 7 of the drawings is a View Market Window in one potential embodiment of trader client 200; and

FIG. 8 of the drawings is a non-exclusive list of Quick Entry language command syntax.

### DETAIL DESCRIPTION OF THE PREFERRED EMBODIMENT

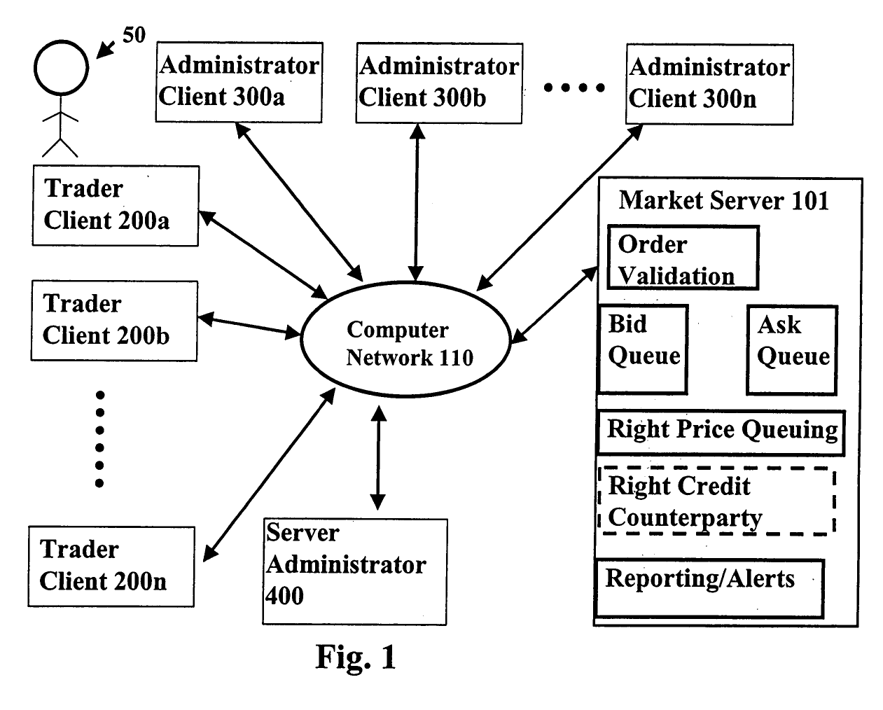

FIG. 1 is a block diagram overview of the various components of the present inventive system. In particular, system 100 includes market server 101, trader clients 200a-n, administrator clients 300a-n, and server administrator 400. It is critical to the present system that at least market server 101 and each of trader clients 200a-n are able to communicate in real-time.

As shown in FIG. 1 each of trader clients 200a-n, administrator clients 300a-n and server administrator 400 are operably connected to market server 101 via computer network 110. Computer network 110 is any computer network that allows multiple computer systems to communicate with each other such as a Local Area Network (LAN), WAN, Intranet or the Internet using standard communications protocols. It should also be noted that computer network 110 could comprise the public telephone network with market server 101 acting as a dial-up bulletin board and the trader clients 200 dialing in directly to market server 101 via the telco network. Of course, each trader client 200 can be operably connected to market server 101 using any of the foregoing types of networking approaches and none need to connect via the same networking approach.

Trader clients 200a-n each preferably run on a general-purpose computer system such as an IBM compatible, Apple, or other equivalent personal computer that allows a potential trader to communicate with market server 101 via computer network 110. The general-purpose computer system further includes a network interface that allows for communications with the computer network and may include any Internet capable software program such as Netscape Navigator, Microsoft Internet Explorer, Mosaic, or their equivalents.

The market server 101 is preferably a general-purpose computer system such as an IBM compatible, Apple, Unix type workstation, or their equivalents that can facilitate inquiries from multiple simultaneous inquiries. Market server 101 must also have a network interface that allows for communications with the computer network and may include Internet server software. Of course, market server 101 and trader clients 200a-n need not be running on the same type of general-purpose computer for the present system to be operational.

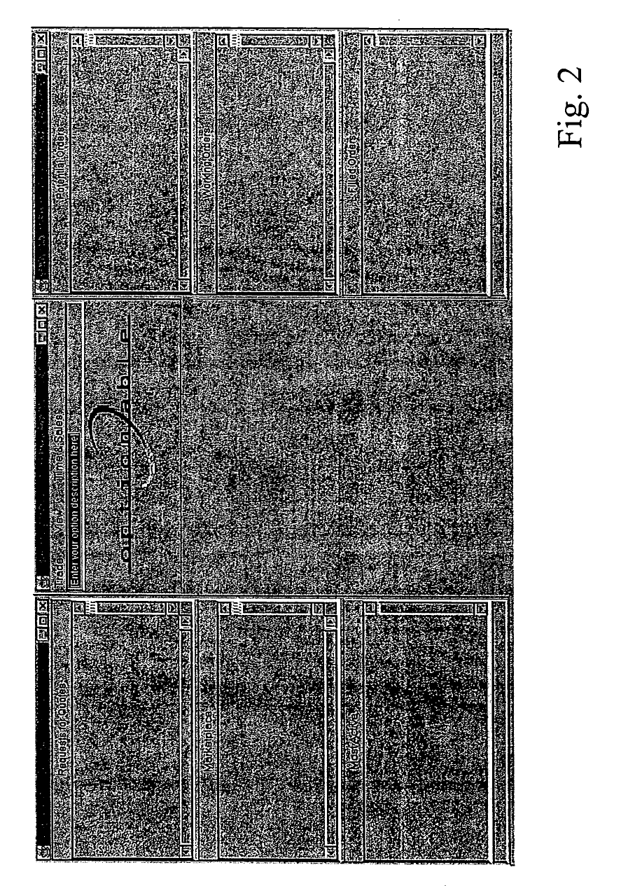

Using trader client 200 to operably connect to market server 101—in a well-known manner dependent upon the technology of computer network—users will access various user interfaces, which may take the general form depicted in FIGS. 2 through 7. These figures suggest the use of Java applets in a WINDOWS 9x environment. Of course, while the present disclosure is being made in a Java/WINDOWS 9x type environment, use of this environment is not required as part of the present invention. Other programming languages and user-interface approaches may also be used to facilitate data entry and execute the various computer programs that make up the present invention.

Market Server 101

Market server 101 is the focal point and final arbiter for order processing and trade execution with respect to sequencing and timing. In particular, market server 101 should:
Accept, process, store and distribute “Request for Quotes” (“RFQs”), quotes, orders, executions, confirmations, and rejections and other system messages in real-time;
Maintain a repository of market participant information (users, traders, administrators);
Screen trades based on party identity;
Maintain message and activity logs suitable for history and to support billing purposes;
Facilitate instant messaging from market server 101 to trader client 200 users for system status and system announcements;
Provide price transparency by distributing all quotes and orders in a particular Underlying market (e.g. natural gas, cotton, gold, stocks); and
Provide settlement support including reporting of firm wide and per user activity on the system to allow easy integration with each firm's settlement systems.
   Market server 101 may also provide:
Limited anonymity (market participants may choose not to identify themselves to other participants before the trade, and need only reveal their identities to counterparties after the trade);
Credit Facility interface (trades may be approved in real-time by third-party guarantors);
Distribution of market updates through e-mail, fax and pager;
Trade screening based available credit and firm-assigned risk; and
Cash settlement facilities.

Market server 101 includes a user entitlements handler that maps user IDs associated with incoming messages and other service requests with the stored security permission information related to the user type of the user making the request in order to authenticate users to the market server, and toward checking whether the user ID is entitled to perform the requested operation.

Market server 101 further includes an order matching handler for reviewing all currently active orders and quotes, executing any trades possible according to pre-programmed matching rules, modifying orders and quotes according to the matching rules, and providing confirmation to all traders effected by the resulting trades. In particular, trade will occur when the “Right Price Queuing” rule is satisfied. In a preferred embodiment, a trade will not occur unless the “Right Counterparty Rules” is simultaneously satisfied.

The Right Price Queuing Rule

Instruments only trade among themselves; they are not able to trade with another instrument that differs from them in any detail, except that hedged instruments need only match on the net delta. To facilitate these trades, each Instrument has a bid queue consisting of bids and an ask queue consisting of asks. Thus, when a bid on a particular Instrument reaches the market server 101, it is placed in the bid queue for that Instrument (after execution of any pending trades) based on its price (better prices move further forward in the queue) and time (earlier bids stay ahead of later bids of the same price). As a result, the best bid (highest bid) is the front of the bid queue. Likewise, when an ask on a particular Instrument reaches the market server 101, it is placed in the Ask Queue for that Instrument with the best ask (lowest offer) ending up at the front of the ask queue.

An Order remains in its queue (bid or ask) until it is:
a. traded in the market server 101,
b. killed by submitting trader,
c. modified by a trader (subject to certain exceptions described below), or
d. removed by the System either because of an Administrative activity or because the Order times out.

Preferably, a quote lives in the queue like a market order, except that it removes itself from the Queue after a short (10-sec.) timeout. It would be known by those in the art to extend or decrease this time keeping in mind that the longer the quote is maintained the more likely it will be stale.

The order is traded when Best Bid>=Best Ask, thus satisfying the Right Price Queing Rule, with the trade price being the best ask. The number of contracts that trade as a result of a match is the lower of best bid size and best ask size. Consequently, if the best bid size and best ask size are different and then the lower one will be completely filled, and the higher one will be “partially flled” with a remainder. If a partially filled trade of Instruments involving Hedged Contracts would result in a fractional hedged quantity being traded, then the orders do not match. Every time the best bid or best ask changes (represented by a change in the order at the front of the bid or ask queue), the System sees if it can execute a trade, and will keep trading until best bid <best ask. The number of contracts that have been traded is reported to all counterparties.

The Right Credit CounterParty Rule

In one embodiment, each Firm F in market server 101 has a Counterparty List (CL) that consists of other Finns F1, F2, . . . Fₙ that firm F accepts as potential Counterparties to a trade. Thus, each market bid in the bid queues is associated with the submitting trader 50 and the submitting trader's Firm. According to the “right credit counterparty rule,” even if the Right Price Queuing Rule indicates that two orders should trade, if the best bid firm does not have the best ask firm in its counterparty list or visa versa the best ask firm does not have the best bid firm in its counterparty list the trade will not execute. Instead, market server 101 will continue past that unexecutable bid-ask match to the next order in the respective queue and attempt to satisfy the Right Price Queing Rule. No orders are removed from the queues for failure to satisfy some firm's right credit rule.

All messages sent by traders to the market server 101 will be validated before being placed in either queue. Messages that do not pass validation are rejected, and a rejection message is sent back to the trader client of the sending user. Some validation is also performed by the trader client 200, in addition to the validation performed by the order validation service at the market server 101. This double validation is desirable to provide both timely feedback to the user during the order entry process, and to provide an independent and reliable back-end service.

Trader Client 200

Trader client 200 provides a computer interface for a human trader 50 to enter and transmit commands (i.e. RFQS, quotes, orders) in substantially real-time to market server 101; receive and display real-time updates from market server 101; and to submit information inquiries regarding the past and current state of the market in substantially real-time. In one approach, trader client 200 allows trader 50 to customize screen layouts, and automatically restores the most recent screen layout upon login.

In a preferred approach to system 100, login includes selection of a particular-underlying market for the present trading session. In this approach, for instance, trader 50 could enter the market for natural gas or precious metals. In such an approach, the trader would be required to exit one underlying market to enter another underlying market. Other approaches where multiple underlying commodities are trading in one session are contemplated, but are believed to be undesirable because of the volume of potentially unnecessary information that would clutter the trading screen, thus, interfering with trader 50 ability to understand and react to any one underlying market.

After a successful login, a series of information windows appear. One potential configuration is shown in FIG. 2. As noted above, this configuration may be configured by human trader 50 from a standard configuration. As would be understood by those of ordinary skill in the art, the number of windows that can be simultaneously displayed is limited by physical screen size and readability. As is also known, windows may be tiled, cascaded and hidden behind other windows and later brought into view by standard operating system techniques.

In one approach to trader client 200 shown in FIG. 2, the information windows can include main application screen 201, which has a menu bar containing at least “trade” . . . “view,” and “time & sales” menus. Other commands may also be provided on the menu bar, such as a pull-down “help” menu to provide on-line documentation and information regarding system 100 and trader client 200, and options to print the data in the currently active window, exit trader client 200 and set workstation customization options (e.g. displayed windows, prompt messaging activation and reception of alert messages).

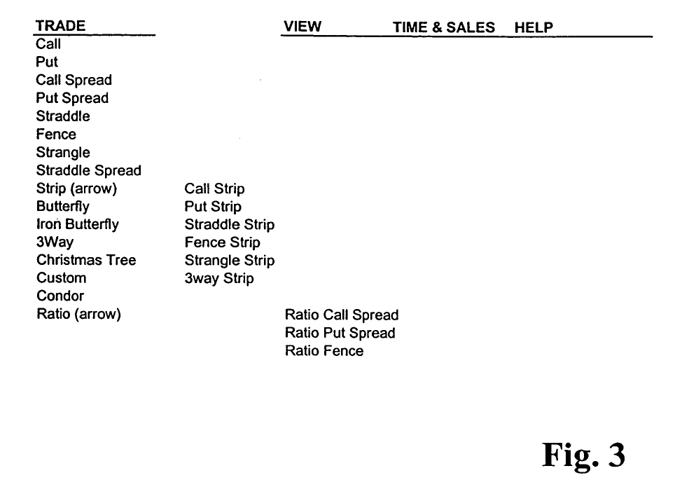

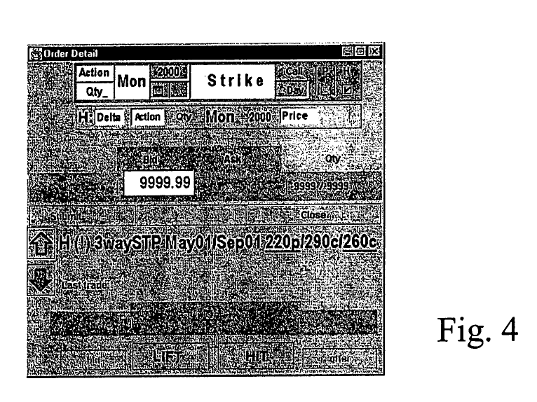

In the depicted approach to trader client 200, a “trade” pulldown menu is provided to facilitate quick creation of various options contract types including, but not limited to the most commonly used types (e.g. calls, puts, call spreads, put spreads, fences, strangles or straddle). In one approach, shown in FIG. 3, the “trade” pull-down menu is multi-layered to further facilitate quick creation of contracts. It is preferable for these menu selections to be further supported by a dialog box tailored to the selected option type, such as provided via a new order entry card. For instance, the dialog box shown in FIG. 4 would be populated (and/or modified) based on the pull-down Menu Selection.

In a preferred embodiment, system 100 supports trading of in excess of 100,000 different options types in 240 months (a 20 year window from the current date) in various underlying markets. The number of options and available months, of course, is a matter of design choice. Regardless of the volume of information, human trader 50 may wish to focus on a segment of the market in determining upcoming trading strategy.

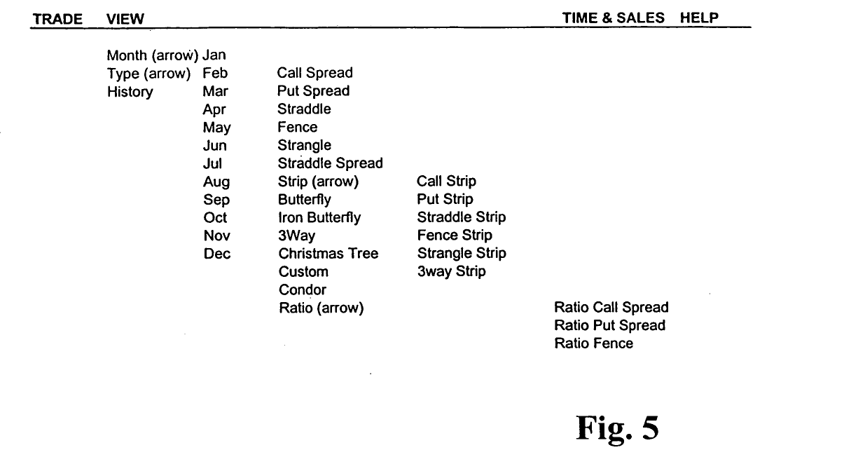

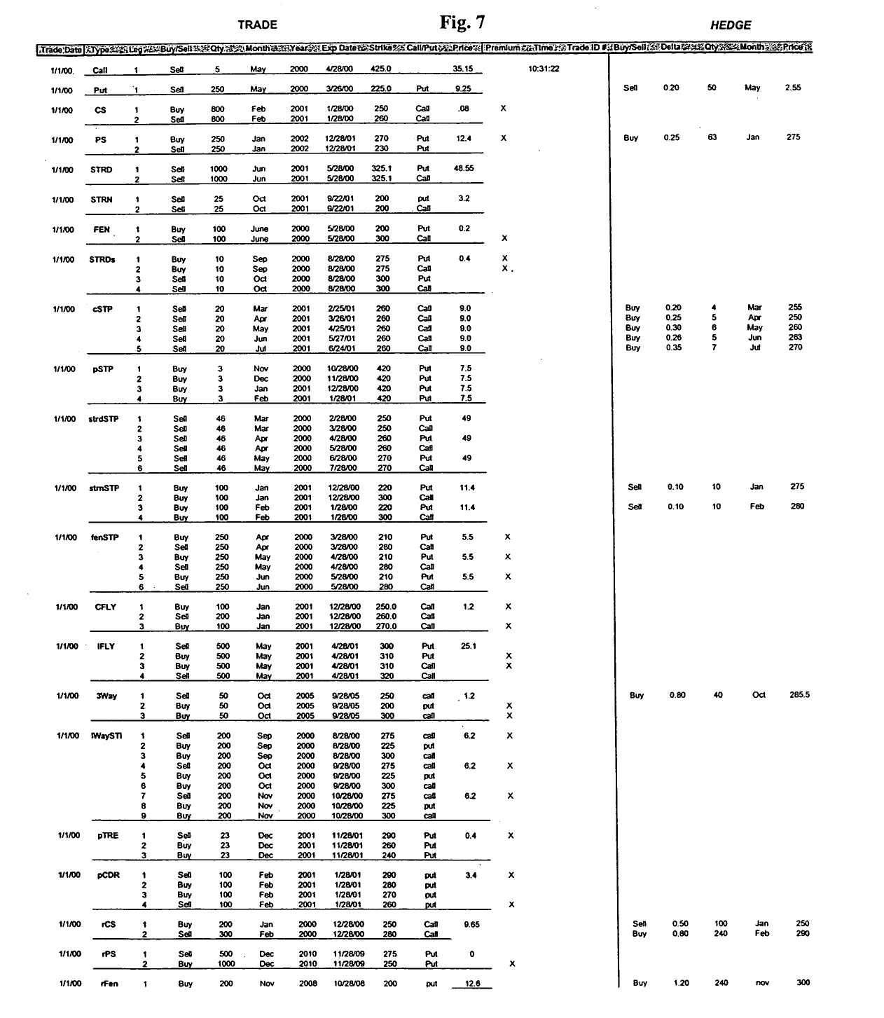

The “view” menu offers a mechanism for human trader 50 to review selected portions of trader 50's past trading history on the computer screen. For instance, in one approach to trader client 200, the “view” pull-down menu facilitates quick selection of months and contract types, respectively using multi-layered pull-down menus (see FIG. 5). Alternatively, trader 50 may selected a particular trading date, which would result in the display all trades transacted by trader 50 on that date, such as is shown in FIG. 7. Of course, other approaches to displaying and selecting a alternatives from a list are well known to those in the graphical user interface art and may also be used to facilitate this functionality.

The main application window 201 shown in FIG. 2 further includes a “Time & Sales” menu which displays—in a fashion similar to the view window—the status of all the human traders in the current market, thus the same types of data are displayed by both “view” and “Time & Sales” menus (an exemplary view window is shown in FIG. 7). Similarly, the same type of multi-layered pull-down menus provided under the “view” menu exemplified in FIG. 5 would likewise be provided for the “Time & Sales” menu. Of course, it would be understood to those in the art that other displays and means for filtering the displayed information can be used.

At the bottom of the main application screen 201 (FIG. 2) is a status bar 202. The status bar is preferably divided into two sections. The first section is a message area that displays any relevant information for the user (e.g. “Submitting order to market server” “Order acknowledged by market server, Order number is ABCD123”, “Order rejected by market server. Invalid option types ‘XC’”, “Order ABC123 executed”, “Submitting modify request to market server for order ABCD124 . . . ”, “Modify request received for order ABCD124.”) The status bar message area may also retain a history of the messages it has displayed. As is known in Windows 9x applications, a button may be provided on the side of the message area that pops up a scrolling list of the previous messages in ascending chronological order.

The other side of the status bar monitors the status of the connection of trader client 200 to market server 101. Under normal conditions, this area indicates “Connected,” but may read “Reconnecting . . . ” or “Not connected.”.

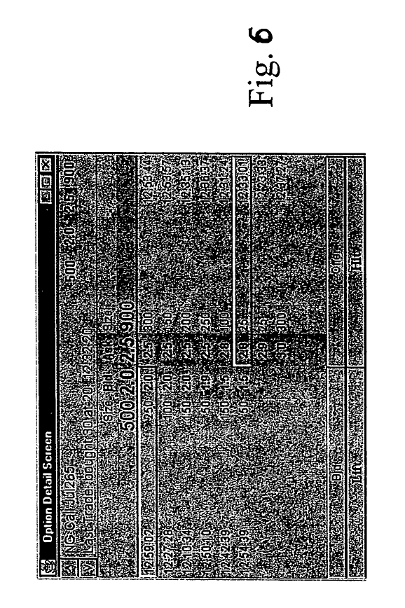

Trader client 200 may also present trader 50 with a number of windows that enable tracking of open orders on the system and a history of activity for the day. Within these windows each instrument is displayed as a Consolidated Summary Line (“CSL”). CSL representation is a valid expression in Quick Entry Language (QEL) that identifies the option type, best bid, size of best bid, best offer and size of the best offer for a particular instrument or contract (e.g. Call May 255). Double-clicking on any particular CSL brings up an Option Detail Screen for the CSL's market (see FIG. 6). The initial state of the Option Detail Screen shown in terms of which of the Option Detail Screen's sub-windows are visible may be governed according to user preference.

As shown in FIG. 6, a full Option Detail Screen has two components: Expanded Summary Line (“ESL”) and a Market Depth Montage (“MDM”). Whether both components of the ODS are shown upon activation depend upon user preference. In one approach (not shown), two buttons, “Contract” and “Depth,” could be physically associated with the ESL, where the “Contract” button toggles the visibility of an Order Entry dialog box and the “Depth” button toggles the visibility of a Market Depth Montage portion of the ODS.

The Expanded Summary Line (ESL) contains two lines. The first line has a contract summary line (“NG Call Jul 265”)and bid/ask fields (“500 2.0 2.5 900”). The second line contains a record of the last trade (price, quantity, side, timestamp) for that contract. The Market Depth Montage breaks out the display of contract type trades by showing a complete and detailed view of each quote and order related to the contract type represented by the ESL.

As shown in FIG. 6, the first line of the MDM has column labels. The second line shows a summary of the best bid and ask, and the quantities at those prices. Subsequent lines in the MDM show ranked summaries of each quote or order active in the market, one quote or order per line, with the best bid and ask sharing the top line and each subsequent line becoming less preferred. Each line has two columns; the columns rank the bid and ask prices. Each column shows the timestamp of when the quote or order entered the market and the price and quantity of the order. Associated with the MDM may be a series of buttons to facilitate Hit, Lift, Bid and Offer operations. The “Hit” button is a one-click way to respond to the best bid. The “Lift” button is a one-click way to respond to the best offer. As shown in FIG. 6, orders entered by trader client 200 will be highlighted in the MDM (such as by the 3D boxes shown in lines 1 and 6 of the MDM of FIG. 6). Similarly, if any of the orders in the MDM were entered by a trader that does not meet the Right Counterparty Credit Rule, those orders will appear differently (perhaps “grayed out”).

In the approach to trader client 200 shown in FIG. 2, in addition to the main application window, six more windows are shown: the Request for Quotes (“RFQ”) window, the Order window, the most active window, potential order window, working order window and filled order window. The RFQ, order and most active windows each show a scrolling display of CSL's that represent dynamically updated requests sent by the various traders using trader clients 200a-n in association with market server 101. The RFQ, order and most active windows start out empty at the beginning of each trading day and have vertical scrollbars that allow the user to scroll back from the current time to the beginning of the day. Orders in the potential order, working order and filled order windows may be sorted by option type, month, year, and strike price based on user preferences, real time selections and/or filtering.

The “most active” window presents a CSL for each instrument of the current underlying that had activity (a new or updated order, quote, RFQ, or trade) within the previous sixty seconds. The rationale for this window is to provide a relatively stable display of current activity that does not scroll too fast for traders to be able to select interesting markets when there is a lot of activity.

The Potential Order Window (POW) (shown in FIG. 2) displays a list of order templates that human trader 50 may complete and submit to market server 101 and, thus, provides a way for a trader to save commonly used orders so that future submissions are quick to perform. The trader may select one or more lines from the Potential Order Window for submission, deletion, or export to Microsoft Excel (or other third party programs). Selected orders may also be dragged and dropped to other windows in trader client 200 where such an operation is functionally meaningful. For instance, an order ca n not be manually moved to the Filled Order Window.

The Working Order Window (WOW) (shown in FIG. 2) displays all orders placed by trader 50 that are open at the current time (including orders that are only partially filled)(completely filled orders are automatically moved to the filled orders window in real time). The orders are displayed using CSL in a table, which dynamically grows in size as orders are entered over the course of the day. The rows may also dynamically update as the orders change status (i.e. partially or complete filled). The trader may kill selected orders in the working order window, which would—in a preferred approach—bring up a dialog box to confirm the kill. Once confirmed, the “Kill” sends a request to market server 101 to kill the order. When the request is acknowledged, the order changes state from “Pending” to “Kill”. When the Kill is completed, the order changes state to “Killed”.

The trader may similarly seek to modify a selected order by—in the depicted embodiment—bringing up a dialog box prompting the user to enter the modified order information. To assist the trader with the modification, the fields are preferably initially populated with the values of the original order. Only certain fields can be modified with the other order fields being displayed as read-only. Certain read-only fields can become editable when they become relevant in the current trade.

If any property of the order is modified other than a lifetime or downward quantity modification, then the order is not modified at its current place in its respective queue, but rather it is killed after a new order is submitted to the respective queue reflecting all the values input into the dialog box. Thus, the primary functional differences, from the user's perspective, between a modified order and a kill/submit sequence is that a newly submitted order has a new order ID and is entered at the bottom of the order queue, while a modified order retains its ID and position in the order queue.

The Filled Order window (shown in FIG. 2) lists all orders that have been executed during the current day, which dynamically grows in size as orders are executed (or filled) over the course of the day. The order tables may also provide the ability to expand or collapse the display of information supporting a displayed trade (i.e. displayed if multiple trades were executed to fill or partially fill this order).

FIG. 7 depicts exemplary information that would be displayed in a view market-window. The entries in this window may be sorted and filtered according to various criteria selected by the trader 50 using various techniques, such as the multi-layered pull-down menus shown in FIG. 3. Similarly, a history view window can be generated depicting trade history of one particular trader filtered for a particular date (i.e. Jan. 1, 2000), including all the relevant information regarding the trade. The trades shown in the history view can be selected and dragged into other windows (at least where functionally logical) toward placing a similar order in the active market.

In general, a new row is added to the bottom of a window each time an update is received by trader client 200 from market server 101, unless an instrument's CSL is already in the visible portion of the window, in which case the CSL updates in place within the window. For each window, detailed information (ODS, OEC, ESL and MDM) may be viewed for each trade, as well as summary-only information. A view of the orders can also be sorted or filtered based on various parameters including option type, hedging information (expiration date, strike price, ask price, bid price). The view may also show summaries for all markets, or be filtered to show only markets where the trader has orders, or only markets where the user has orders at the money. The times displayed in these windows are relative to the time zone of market server 101. Orders displayed in these windows may be dragged and dropped into other windows where such transfer makes functional sense.

Orders in a “Potential order” window do not change state, unlike orders sent to the market, which change state depending on what happens to them in the market (e.g. acknowledged, partially filled, lied, killed, etc.). Trader 50 can select and send individual or multiple orders from the Potential Order window to market server 101 for execution. Multi-order submissions are only a shortcut for the user. System 100 actually submits each order individually to market server 101, which maintains no connection between simultaneously submitted orders.

A trader may enter orders, modify any of his working quotes or orders and execute a kill function. Orders, quotes and RFQs can be manually entered on an order entry card, a Quick Entry Language Line, by dragging and dropping a consolidated summary line (“CSL”) into the “working order” window or “potential order” window, by “hit” or “lift” operations or imported from Excel spreadsheet by a drag-and-drop mechanism. (Conversely, orders can also be dragged from the Potential, Working or Filled Order Windows and dropped into an Excel spreadsheet). The following data is generally common to all RFQ, quotes and orders (bid/ask price and quantity fields not required for RFQ):

| | |
|---|---|
| Contract Type | The type of option to be traded, usually an |
| | underlying commodity type such as crude oil |
| | or natural gas. |
| Side | Buying or selling |
| Quantity | the number of contracts of this type to which |
| | this order or quote refers |
| Expiration Date | For exchange-traded look-alike contracts, this |
| | will be an alphanumeric code for the month |
| | field, and a choice of numeric year values from |
| | the current year through 19 years out. (In one |
| | embodiment, the year defaults to the closest |
| | later date (i.e. if order entry occurs on Jan. 31, |
| | 2000, then a March contract defaults to 2000, |
| | while a January contract defaults to 2001). |
| | For non-standard contracts, the user specifies |
| | the actual expiration day, month and year. |
| Strike Price | The price at which the underlying contract will |
| | be delivered in the event an option is |
| | excersized. |
| Bid Price | The price at which someone is willing to buy |
| | the underlying. |
| Ask Price | The price at which someone is willing to sell |
| | the underlying. |
| Premium | a Boolean field that indicates that this leg has |
| | the higher value; that is, this is the leg whose |
| | price is traded upon |
| Hedge | A Boolean field that indicates whether to |
| | hedge the order with futures contracts for the |
| | underlying, with the following parameters |
| | Hedge Delta (“hedge ratio”) - the quantity of |
| | hedges to buy, expressed as a percentage of the |
| | order quantity |
| | Hedge Expiration Date - the expiration date of |
| | the hedges (defaults to expiration date of the |
| | quote or order). |
| | Hedge Price |
| | Hedge Quantity - a calculated field which is |
| | the result of multiplying the Order Quantity by |
| | the Hedge Delta rounded to nearest whole |
| | number |
| Underlying Quantity | If changed from default Quantity (Lot Size)for |
| | the Underlying, the contract described by the |
| | Order becomes a non-standard contract. The |
| | number of the underlying represented by a |
| | quantity 1 option contract. (A non-standard |
| | contract size whose Quantity field equals 1 |
| | effectively makes the trade “All or Nothing.”) |
| Settlement Type | If changed from the default settlement type for |
| | the Underlying, the contract described by the |
| | Order becomes a non-standard contract |
| Delivery Point | If changed from the default delivery point for |
| | the Underlying, the contract described by the |
| | Order becomes a non-standard contract |
| Order Type | Orders default to limit orders. Stop limit X-As |
| | soon as the market trades at X or lower, submit |
| | order to the matching process at X. |
| Fill or Kill (FOK) | an order that times out after 30 seconds - |
| | similar to a quote except that it is one sided |
| | and lasts longer |
| One Cancels the Other | If one order is filled (completely or partially), |
| (OCO) | then the other is killed |
| Time Limit | specified number of seconds (10 is default for |
| | Quote) Day (default for Orders) Good Till |
| | Cancelled (GTC) |

When a quote, order or market summary line is selected, the trader may double-click on that entry prompting trader client 200 to display an order entry card (FIG. 4) window automatically populated by trader client 200 with values calculated to optimally execute against the selected quote or order. The order entry window also provides means for the trade to hit the bid, lift the offer, change a bid price or quantity, change an ask price or quantity and/or save the order to the “potential order” window. Once one of the actions above is selected, the trader is then presented with a detailed display of the order to be submitted, which is reviewed and modified as desired and then the trader specifies the submit, replace, kill, or potential order actions.

Of these possible actions, only the replace action may need additional explanation. For example, if the order being responded to is the user's order, then the existing order's quantity is decremented by the quantity being submitted and a new order is placed for that quantity. If the decrement is unsuccessful, the replace operation is aborted, and a user is informed that nothing happened. If the decrement could only be partially performed, then that is counted as a successful decrement and the new order is submitted but with a quantity adjusted so that the sum of the decrement orders quantity and the new order's quantity does not exceed the quantity of the decremented order's quantity prior to replacement.

The main application screen contains a Quick Entry Language Line (QELL), into which commands written in Quick Entry Language (QEL) are typed. Some QEL sequences cause Order Entry Card (OEC) or New Order Entry (NOE) screens to be spawned. As shown in the version of trader client 200 depicted in FIG. 2 a Quick Entry Language (“QEL”) Line appears immediately below the menu bar. In particular, the Quick Entry Line allows trader 50 to enter the information for an order using a basic notation to represent the order parameters. QEL represents a faster entry method to make experienced users of trader client 200 more productive.

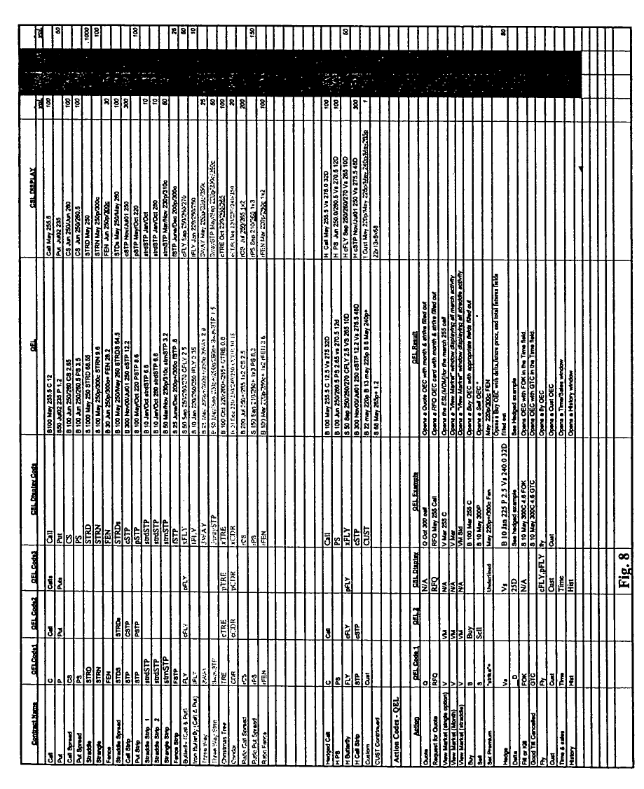

The Quick Entry Language (“QEL”) provides a keyboard-based quick-entry format for fast order creation by experienced users. QEL is provided as an alternative means of command entry in addition to the more user-friendly, mouse-based, click and type method. It is possible to express most of the actions relevant to RFQ, quote and order entry in a compact character-oriented format. In addition, some QEL commands offer the ability to manipulate or navigate other Trader client 200 functions. This language is specified as follows:
[Underlying] Action Quantity Month[Year] Strike Option-type Price [VS Hedged Delta] or
Underlying Option-type Action Quantity Month[year]Strike Price Vs. Hedged Delta Optional elements are specified in square brackets all other elements are required to completely specify an instrument. (However, incomplete QEL expressions are often used for specifying a View Market filter or partially completing an Order Entry Card.). A non-exclusive list of “actions” facilitated by system 100 is shown in FIG. 8.

As also shown in FIG. 8, QEL supports reordering of elements so long as there is no possibility of ambiguity in the reordering. QEL supports both net and per-leg hedge deltas. For example a trader on Feb. 10, 2000 could enter the order express: “Buy 100 June 2000 75 Calls at 15” in these ways:
B 100 Jun00 75 C 15
100 Jun 75 CALL 15B
CALL B 100 Jun00 75

The order entry date needs to be specified for this example because QEL year defaults are relative to the date on which they are being interpreted. Standard expirations are always month or Month Year. Non-standard expiration dates are entered and displayed as NSD:Month,Day,Year. Non-standard delivery points and settlement types are entered and displayed by modifying the underlying symbol with colon separated symbols. For example, a Natural Gas contract delivered in Denver settled in cash might be NG:RKY:$$.

Human trader 50 can assign a name to any selected custom order for fixture reference. This new type name would be automatically recognized by QEL, appear on the Main Application Screen Contracts and Windows View Market submenus. However, since this assigned name is local to the trader who defined it, the name not recognized by the matching engine sub-system of market server 101, which would continue to treat the order as custom.

The following examples are of the QEL language:

| Example | Description |
|---|---|
| NG V Mar 55 C | Shows the market on the natural gas march 55 |
| | call |
| NG B 100 Mar 55 C 230 | Buy 100 Mar 55 Call at 230 |
| NG S 100 Mar 55 C 230 | Sell 100 Mar 55 Call at 230 |
| NG Mar 55 C RFQ | Sends a request for quote on the March 55 call |

The user may enter a hot key sequence that performs a pre-defined action in trader client 200 application. In one approach, there are hot key sequences for the following actions: (Bid; Offer; Hit Bid; Hit Bid for X Quantity; Lift Offer; Lift Offer for Y Quantity; Kill Order, Kill All Orders—(enters them into Potential Order window)).

The Order Entry Card (such as that shown in FIG. 4) dialog box is an entry screen for the specification of orders, quotes and RFQ. Each of the standard contract types (e.g. call, put, butterfly) has its own OEC. Suppose one wished to execute a 50-60-70 call butterfly, the EOT would capture the whole pattern as a call “butterfly” and trade it as a unit, instead of by specific components. With the QEL language, one could simply type cfly 50-60-70 and the system would understand that it is a 50-60-70 call butterfly and a OEC would automatically pop open and complete it based on whatever you was previously entered. In addition, an OEC for custom contracts may be used to enter orders for option types that are not predefined to system 100. Among other information, the OEC should display the name of the contract type. If the contract is hedged or has a nonstandard delivery point or settlement type, then the word “Hedged” and the symbols representing the delivery point or settlement type, respectively should become part of the contract name display.

The OEC may contain one or more contract legs, which are graphical representations of puts, calls or futures. For instance, the legs of a contract that are being bought can be represented in one color with one graphical prompt and legs being sold could be represented in another color with another graphical prompt. If a leg does not (yet) represent a bid or offer (for example, the OEC is for an RFQ or is unspecified), then there would be no graphical prompt on the leg. The legs have a number of fields, which may be active, passive, or protected, including Underlying; B/S/R—Buy/Sell/RFQ; Quantity; Expiration Month; Expiration Year, Strike Price; Put/Call; Day; Special (delivery points and settlement types); Hedge area (Delta, Date and Price). The OEC may also include bid and/or ask price fields, except in an OEC for an RFQ.

The bottom portion of the OEC may optionally contain a set of buttons relevant to the context from which the OEC was spawned. These can include view market, potential order, submit order, replace order and kill order. Some option types require the quantities of each leg to be in a particular ratio to the other legs and, thus, will have numbers representing the ratios visually associated with each leg.

An OEC that is intended to be used to enter a new order is called a New Order Entry screen (NOE). In a NOE, some fields will preferably be auto-filled with default values, which trader 50 can then manually change if desired. For example, all quotes may start with their quantity field's value set to 10. Some fields may also be filled in from the context that invoked the NOE.

In the event a hedging contract is entered into trader client, client 200 determines whether the hedge ultimately results in the buying or selling of hedge contracts. In the first event, a Buy Call is equated to Sell Hedge; Sell Call is equated to a Buy Hedge; Buy Put is equated to a Buy Hedge; and Sell Put is equated to a Sell Hedge. Where the hedge is multilegged, the net delta is actually the traded order. For example, a Buy of 50 Call Butterflies with a 18/12/10 delta operates like this:
B 50 Mar01 50/55/60 CFLY 10D=
B 50 Mar01 50 C/Sell 9 hedge
S 100 Mar01 55 C/Buy 12 hedge
B 50 Mar01 55 C/Sell 5 hedge

Therefore, the Net Hedge=Sell 2, 2D. Thus, trader client 200 should enter the hedge for an entire multi-leg order as a net hedge directly as a single hedge on one leg of the Order, and need not specify separate hedges for each leg. This minimizes the number of unnecessary orders placed on the market server.

When one executes an option trade, one uses a “Delta” to determine what amount of the underlying contract one should buy or sell to offset the trade one did in the option in order for one to have less risk. As an example, suppose there is a June 250 call, with a 10 Delta and one is buying 100 of it. This means it is just a percentage (10%). So one would execute 10% of the underlying against the call. So if one buys 100 June 250 calls, one is going to hedge it by selling 10 June futures. Traditionally in the market, one would buy 100 June 250 calls in the options ring and will than turn around to the futures ring and sell 10 June fixtures. Traders often execute a “laid up”—that is that they execute it as a package, because they wish to “hedge” themselves and relieve themselves of this extra futures risk. In the present system, we could just click a Hedge button, which would open up Hedge Fields that are related to each of the months. Thus, since one is hedging with the underlying futures, if one executes a June 250 call and a June 300 call spread in the same month, one would only have to hedge it once because one is only hedging June futures. But if one did a calendar spread (lets say a June 250 and a July 300 call), than he is trading two different months and, one would have to hedge the June futures and the July futures separately. In the first example, they are in the same month, and one could just net out the hedge.

Some instrument types require the specification of quantity ratios between contract legs. On input to the trader client 200, all ratio trades will adjust their ratio and quantities automatically according to the least common divisor between the ratio elements. For example, an order for 200 2×4 Call Spreads will be entered as 400 1×2 Call Spreads. This will reduce the proliferation of disjoint ratio markets and help to increase liquidity in market server 101.

Custom option types may be specified—these are any sequence of put, call and “lookalike” futures contract legs and hedges that do not match the sequence (and their inter-leg constraints) that compose the system-defined option types. Custom orders allow the specification of ratios between each of their constituent legs.

An RFQ is a message broadcast to all interested market participants for price and quantity quotations on a particular underlying commodity (i.e. crude oil). Generally, an RFQ is sent when there is no activity (outstanding quotes or orders) relating to an underlying, though it is also appropriate to send an RFQ when the activity is low. Once all the required fields of an RFQ have been specified by a trader, it may be sent to market server 101. If the market server accepts the RFQ, the RFQ appears in the RFQ display of all other trader clients logged into market server 101. In one approach to the present invention, as the RFQ is sent to market server 101, trader client 200 also generates a potential order for that RFQ that requires manual insertion of only bid/ask price and quantity fields to make it a valid order or quote which can then reside in the potential order window of the trader client.

When market server 101 sends a message to trader client 200, it is available for viewing by the trader in summary of detail forms. Traders may even scroll through all messages received in a particular session.

Trader 50 may specify and save various application preferences that affect the operation of that trader's trader client 200. System 100 automatically saves trader's preferences after the user changes their values. For instance, these changeable preferences may include: Time Zone; Quote Expiration Time; FOK Expiration Time; Default Quote Quantity; Default Limit Order Quantity; and windows shown when displaying Option Detail Screen.

Alerts are dialog boxes that pop up on a user's screen that the user must affirmatively close. The user can configure trader client preferences to indicate which alerts should be received (executions, rejections, kills and system status messages). All alert messages appear in the status bar, regardless of the user's preference settings.

Before executing a user's request to initiate a significant transaction or a state change, the system can be configured to ask the user whether to proceed. This is a precaution against user mistakes. The confirmation is in the form of a pop-up dialog. Often the pop-up dialog looks like an order entry screen. In some approaches, confirmation can be turned on or off as a user preference. Trader client 200 may also provide an API for a user to send the details of a potential order prior to submission to a third party analytics package. The third party package can calculate a bid and ask price then can be inserted into the order details. The user may then review the results, and submit the order.

Administrator Client 300

Administrator client 300 provides a computer interface for trading firm administration staff to manage traders and counterparties. Among other functions, administrator client 300 should manage traders, firms, underlyings and contract specifications, send and receive system messages, kill orders and reverse trades for traders and monitor the status of users and market server 101.

As an adjunct to the various monitoring capabilities, administrator client 300 can also log trades for later analysis. For instance, administrator client 300 may provide both current and historical information of trades and activity by firm related traders. In one approach, the reports could be either viewed online or downloaded into a third party spread-sheet program, such as Microsoft Excel by Microsoft Corporation of Redmond, Wash.

Server Administrator 400

Server administrator 400 provides a computer interface for managing users, option types, underlying commodity types, and system monitoring.

System Operation

In operation, trader 50 launches trader client 200 on the local computer and enters a user ID. Trader client 200 then retrieves a local list of underlyings that trader 50 is authorized to view and/or trade. A list of allowable contract types is loaded into trader client 200 from market server 101 each time the trader client 200 starts up. This underlying list having been established and perhaps previously modified by market server 101 during a previous session, trader 50 selects an underlying commodity to view or trade during the present computer session and provides his password associated with the user ID. (The underlying or contract type is generally fixed for a session with all subsequent operations referring to that type.) The login request is then submitted to market server 101, which verifies the User ID, Password, and rights of trader 50 to trade in the selected underlying market. If trader 50 passes security measures, then market server 101 sets entitlements, retrieves the default user preferences, displays one or more application screens in a layout determined by the retrieved preferences. Market server 101 displays all pending messages for trader 50 received since the last log out.

Basic Path for Submitting A Working Order:

Trader enters all required fields on the Order Entry Card.
Trader client 200 validates the field values against the applicable Order Validation rules based on current knowledge.
The user submits the quote or order to market server 101.
Market server 101 authenticates and validates the submission against the order validation rules.
The system acknowledges the quote or order to the user.
The accepted quote or order is submitted to the Order Matching service.
If matched, the order executes, and trade confirmation messages are sent to each trade counterparty.
Market server 101 then modifies the quote or order according to the trade activity.
The Market server 101 broadcasts the resulting status to all interested market participants.
Quote or Order is Rejected by Validation Rule. If market server 101 does not successfully authenticate or validate the quote or order, market server 101 sends a rejection message to the submitting user.
Market server 101 is then closed. i p.

The concept of “negative pricing” raises particular problems when trying to move an options trading system from a trading floor to an EOT when, in trading certain option strategies (combinations) the price of the first leg that one is buying versus the prices of the leg one is selling in the combination could be a net value of zero or close to zero. A trader can use a negative bid or offer when he is quoting a trade whose 2 sides are of approximately equal value. This scenario can occur in the following trade types:
straddle spread, fence, calendar call spread, calendar put spread, calendar fence, ratio call spread, ratio put spread, ratio fence, 3way, fence strip.

Suppose there is a May 400 call (c) and June 450 call (c) and someone is interested in trading in combination (this is known as a Calendar Call Spread and involves the simultaneous purchase of one of these options and sale of the other). Let's say that the value of the May call is $50 and the value of the June call is $100. The value of the spread is therefore $50 (because you are buying one option and selling the other). If a trader wishes to make a $5 profit trading this spread, regardless of whether he intends to buy the June 450c or sell the May 400c (buy the spread) or sell the June 450c and buy the May 400c (sell the spread), he would make the following 2-sided quote:
May 400c/June450c $45 bid $55 offer
   Which means he wants to either, buy the June call and sell the May call and pay $45 to execute this trade (it's worth $50 so it's a good deal). Or sell the June call and buy the May call and receive $55 to execute this trade (it's still worth $50). Now suppose the May 400c is worth $99 and tie June 450 Call is worth $100 (the spread is worth $1). If the same trader wanted to make a two-sided quote that would ensure a $5 profit regardless of whether he intends to buy or sell the spread he would enter the following bid and offer:
May 400c/June450c $-4 bid $6 offer
   Which means either he will buy the June call and sell the May call and receive $4 (he should have paid $1 for it, a $5 profit). Or he will sell the June call and buy the May call and receive $6 (spread is still worth only $1). It is important to recognize that the following two quotes are mirror images of each other and create the identical 2-sided market. The only difference is that the first quote uses the June call to describe the trade while the second uses the May call. May 400c/June450c-4 Bid 6 Offer=May400c/June450c-6 Bid 4 Offer, because this trade means either buy the May call sell the June call and receive $6 or sell the May call buy the June call and receive $4.

Theoretically it's possible for there to be a negative bid and negative offer on a particular option spread(−50 bid-40 offer). This would be an usual way for a trader to make a quote. Applicants have therefore established a rule that a trader can enter a 2-sided negative market, however, that order will be displayed as it's positive mirror image in the Marketplace window. For example, a trader may enter Jan200p/Feb300p-$15 bid-$5 offer. The marketplace would display Jan200p/Feb300p 5 bid 15 offer, again a mirror trade of the original trade.

To overcome the many hurdles of negative pricing in an electronically traded options system, we have created a series of rules which should preferably be followed.

Trader Workstation (Front End):

Single negative bids (without offers) or offers (without bids) are not displayed.

Double negatives are not displayed.

In the event that there is a negative bid with a positive offer it is displayed in terms of the lower strike.

All ESL's establish for themselves a rule of the premium strike it uses to express negatives and positives at the point it is opened. In other words, whatever the TW is displaying, according to the Rules 0 and 0, at the time the ESL is opened, that will establish the rule for how it will be displayed for as long as it-is opened.

MDM is an extension of the ESL; therefore the open ESL has already established the rule for the MDM.

OEC, when created from the ESL (by pressing: \hat{ }, Hit, Lift, bid, offer), will reflect the rules of the open ESL.

The rules of the OEC when created from scratch, will be established by the order the user enters at that moment.

Working Order Window (WOW):

Your WOW rules are based on whatever the rules for the original order entered, forever.

Market WOW rules are based on whatever the rules for the original order entered, forever.

Filled Order Window (FOW):

The FOW is always displayed in terms that would result in a positive buy or sale. No trades ever occur at a negative price. The instrument description associated with the execution must be displayed in such a way to make the trade price positive.

MarketPlace (Back End):

All orders are displayed in terms of the lower strike in the earliest month.

An implied bid or offer is an order for any SPREAD that is generated by the system to help execute a users trade. For example, if the user is trying to sell a September 50/60 Call Spread for a price of 10 (sell the 50 strike and buy the 60 strike). As soon as the order is entered in the system by the user, the system starts searching for any bids or offers currently in the system, for either one of the legs in that particular trade(in our example the September 50 or 60 call)to offset the trade against. If for example, the system finds a 55 bid for the September 50 call, the system would automatically generate a 65 bid for the September 60 calls. If some other user happens to sell the September 60 calls for 65 then the system would automatically sell the 50 calls to the user who is bidding 55. The system using implied bids and offers has now executed the call spread for the price of 10.

While the preferred embodiment of the invention has been depicted in detail, modifications and adaptations may be adapted thereto, without departing from the spirit and scope of the invention, as delivered in the following claims:

1-28. (canceled)

29. A method of determining trading parties for the real-time trading of options contracts over a network, comprising:
selecting, by a first firm, a second firm, wherein the first firm wishes to trade with the second firm;
choosing, by the first firm, an underlying the second firm can trade with the first firm;
selecting, by the second firm, the first firm, wherein the second firm wishes to trade with the first firm;
choosing, by the second firm, another underlying the first firm can trade with the second firm;
matching the first firm with the second firm, comprising:
determining if the first firm selected the second firm;
determining if the second firm selected the first firm; and
determining if the underlying and the other underlying are the same underlying;
permitting a trade between the first firm and the second firm only if the first firm is matched with the second firm wherein the first firm is a first counterparty to the second firm and the second firm is a second counterparty to the first firm; and
forbidding the trade between the first firm and the second firm if the first firm is not matched with the second firm.

30. The method of claim 29, further comprising:
visually notifying the first firm that the second firm is the second counterparty; and
visually notifying the second firm that the first firm is the first counterparty.
